(19) United States
(12) Patent Application Publication
(10) Pub. No.: US 2020/0019386 A1
(43) Pub. Date: Jan. 16, 2020

(54) INTERLOCKING BLOCKS FOR THE CREATION OF COMPUTER CODE SYSTEMS VIA THREE DIMENSIONAL REPRESENTATION USING VIRTUAL REPRESENTATION, HOLOGRAPHY, AND ENHANCED REALITY

(71) Applicant: Jay Wright, Eureka, CA (US)

(72) Inventor: Jay Wright, Eureka, CA (US)

(21) Appl. No.: 16/033,161

(22) Filed: Jul. 11, 2018

(51) Int. Cl. G06F 8/34; G06K 7/14

(52) U.S. Cl. CPC G06F 8/34; G06K 7/1439

(57) ABSTRACT

The invention consists of dimensional interlocking blocks with computer readable labeling and also human readable labeling on each side. The labeling consists of computer instructions or of sets or lists of instructions. When connected together the computer code is built, and is readable as a system by humans and by computers.

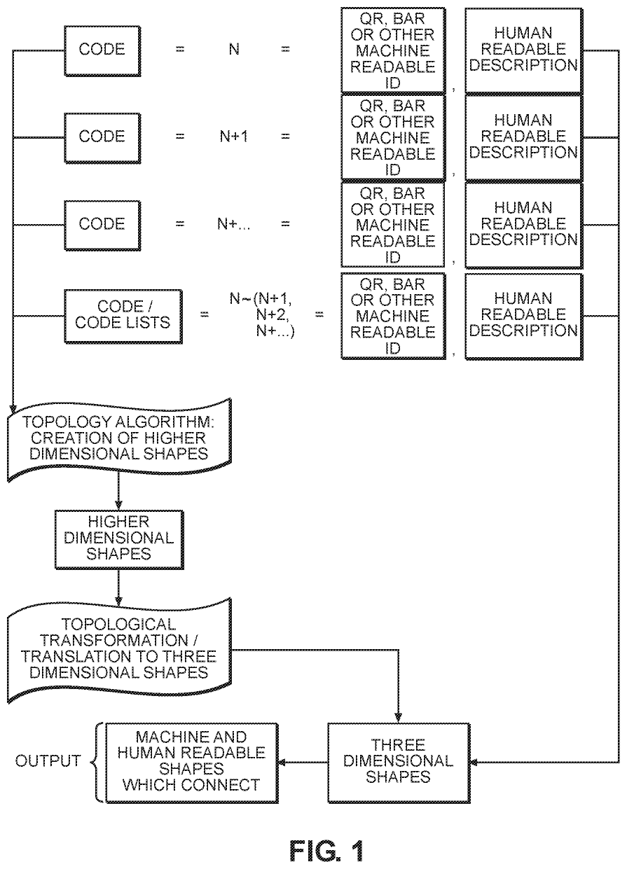

### CROSS-REFERENCES RELATED TO APPLICATION

not applicable

### STATEMENT REGARDING FEDERALLY SPONSORED RESEARCH OR DEVELOPMENT

not applicable

### MICROFICHE APPENDIX

not applicable

### BACKGROUND OF THE INVENTION

### 1. Field of the Invention

The field of the invention relates to the building of computer programming languages, and to holography, virtual reality and enhanced reality.

### 2. Description of the Related Art

Computer programming is a wide field with many topics. Mostly, one or a few topics within a field is picked for study. Arcane terms permeate each field and subfield and relate to interfacing with the computer. This act of creating sets or lists of instructions is what computer coding consists of. This invention seeks to create less distance i.e. more usability of computer code, for and between users at all levels of programming rather than to create a language or system for its creation.

### BRIEF DESCRIPTION OF VIEW OF THE DRAWING

1. The drawing shows a schematic flow chart for the process of converting computer code and human language, represented in higher dimensional topology, into three dimensional shapes.

2. The drawing shows examples of the concept commutation or rejection in building code structures with different blocks in simplified examples. A computer algorithm iteration would build the blocks via 3D printing or schematic. They would likely be complex shapes.

1. Interlocking system of dimensional objects acting as representations of computer coding i.e. ‘code shapes’.

2. Shape as a system for identifying coding type.

3. Code as shapes as a tool to facilitate work with mathematics.

4. Self-rejection of coding errors by the system of connection.
